(19) United States
(12) Patent Application Publication
(10) Pub. No.: US 2012/0141756 A1
(43) Pub. Date: Jun. 7, 2012

(54) BREATHABLE INSECT PROTECTION FABRIC

(76) Inventor: Francesco Ramaioli, Pavia (IT)

(21) Appl. No.: 13/377,601

(22) PCT Filed: Jun. 11, 2010
(86) PCT No.: PCT/IB10/01647

§ 371 Date: Feb. 21, 2012

(30) Foreign Application Priority Data
Jun. 12, 2009 (IT) PV2009A000010

(51) Int. Cl. B32B 7/02; B32B 3/26

(52) U.S. Cl. 428/213; 428/304.4

(57) ABSTRACT

Breathable mosquito-resistant fabric includes an internal layer, outer fabric layer and an intermediate layer, which allows a soft and elastic compression such as springs or an open cell foam. This fabric is suitable for the production of garments and other wearable articles, such as shoes.

The principle of operation of anti-mosquito tissue and/or high breathability is based on the distance that is maintained between the skin and the outer surface of the invention. This fabric is henceforth referred to as system or tissue TTAZ or TTAZ, that Anti Mosquito breathable fabric, or even more simply TAZ (breathable anti mosquito—in italian: traspirante anti zanzara).

The fabric is defined as such even if in reality it is about a group or system established by the use of different materials, not normally used in the textile, linked together with different techniques. The overall system or this (union) will create new usable materials such as fabrics. These new fabrics are suitable for the production of clothing and more.

### Anti Mosquito Appearance

The thickness of the fabric (the invention) is such that the proboscis of the mosquito can not slip into the utilizing product skin (user) and suck blood. The animal's head does not penetrate into the fabric (or below the tissue) and the distance from the skin of the head is greater than or equal to the length of the proboscis. The distance from the skin to tissue (complessive thickness fabric) can be smaller than the length of the proboscis of the mosquito, and also can prevent the insertion of subcutaneous anticoagulant liquid and still be sufficient and effective to prevent puncture and/or removal of blood. This distance can be functional or adapted also to avoid bites or stings from other insects or animals such as horse flies and bees, wasps, hornets and so on.

### Breathable Appearance

The particular configuration of the invention allows breathability perpendicular to both skin and fabric. These skin and fabric tend to be parallel, while the part more outside the fabric is raised from the skin. This particular device allows an additional perspiration in different axes, with particular effectiveness of transpiration with axis and plane parallel to skin.

### Physical Constitution of Product and Manufacturing Method

Physical constitution of product and manufacturing method

The fabric of the invention is composed of several layers. The layer in contact with the skin, called “the internal layer” is preferably a cotton mesh very large, such as a mosquito net or cotton. The mesh size can be very large because it not has an insect screen functions, but only the containment and mechanical retention of the invention and give comfortable contact to the skin.

Therefore I have less material in contact with skin, with greater breathable effect, and with appreciated comfortable result of having smallest tissue quantity in contact with the skin. The outer fabric or the outer layer can be of any type, such as indicating the normal cotton used for build T-shirts and shirts, which may also have a coarse texture and wide.

The effectiveness of the invention is such that the contact fabric with the skin has a texture very wide. It is like wearing only a dress made of a retina, very breathable and large mesh that is invisible because masked by classic fabric outer garment that complete the new invented clothing.

The visible outer fabric is not in contact with skin. Indeed, in the case of application of a shirt, preferably long sleeves, the invention is not easily identifiable because they are not particularly visible at a glance.

The invention achieves the distance from the skin without affecting the aesthetic details of clothing or the generic product that is intended make (also shoes or other). The only important aspect is the thickness: the fabric made has a thickness slightly greater than classics tissues.

The intermediate layer consists of objects in a way that will still allow a soft and elastic compression in order to maintain overall comfort and ease in dressing. In fact it should be limited the stiffness of the system. When used as a support (e.g. the back leaning on a back of a chair) should not oppose a force exaggerated and concentrated and must return to its original position after compression. Can be use a surface that distribute the efforts, including those focused.

The intermediate layer can be formed by springs whose diameter and length, such that it reverse not easy for the slippage inhomogeneous tissue above and below. The diameter of the thread on the spring and its material can be proportional to define the desired characteristics.

The springs or elastic behavior can be achieved through geometry made by plastic or other materials with similar behavior. You can use an alternative or in combination, a cellular system, such as an open cell foam that ensures the pooling of contiguous cells, intended also as cells with upper and lower side compared and contiguous to a hypothetical central cell. The intermediate layer also has breathable barrier that normally do not allow to insects enter. This trick is especially important in the outermost parts like neck and sleeves.

When using a generic tissue for external layer, the TAZ is defined bilayer: in this case the outermost layer is the fabric of application, to which are added to the intermediate layer and inner layer.

In the case of applications that use preformed with to generic tissue, the TAZ is defined trilayer: in this case the fabric of the invention has both a generic tissue and/or mixed, to which are added to the outer layer, the layer intermediate and layer inside.

### Tissues and Technical Systems TAZ

The breathability of the fabric TAZ can be further improved through the use of special fluids, using specific channels with partial breathability guided in the fabric made TAZ (made such as the roots of a tree). So special fluids are guided in the areas of normal transpiration (already described) for this invention.

This device improves the performance of technical fabrics, such as those of fireman, that must withstand high temperatures. For explaining additional details, the fluid can be used a gas coolant (or heating or cooling and heating, including through the use of different fluids), The fluid appropriately channeled and modulated, allows expansion in areas of interest, the latter also undergoes reduction of temperature expansion and transit.

Consequently, the body also benefit from a reduction in temperature to help make your stay in hot areas. The balance of breathable zones from the areas of channeling is calculated in function of the benefits they want to achieve in terms of thermal difference with the surrounding environment. The passage of fluids is facilitated by the establishment of the intermediate layer, which uses the inner layer and outer layer as a guide or channel containment reserved. You can use a network of sensors (e.g. temperature) to check the external surface temperature of the skin to control and direct the release of fluids. The parties to the elastic behavior can be used as electrical contact with the skin for the detection of biological or other parameters for sending electrical pulses to the skin, body and/or muscles and so on. The fluids used can also be used to make flame retardant garment made with TAZ technical: when using inert gas, can turn off any flames. The outer layer may be temperature-resistant materials: further advantage of the invention is that the temperature of the outer material is not transferred to user because the external layer of wearer is not in contact with skin.

### Semi-Technical Tissues and Systems TAZ

Partially using the ventilation system through fluids above described, you can borrow a partial application using simple small fans, which applied to fabrics in specific areas, bring relief to the user. Thinking of the people who regularly wear the jacket over his shirt, this ventilation can force the release of heat from every vent (exit point) possible, such as non-binding example, the sleeves, the chest and neck of the wearer.

### TAZ Classic Fabrics

Even a normal tissue TAZ system realizes the same function of semi-technical tissues above described, since the distance between the outer surface layer of shirt (made with the system TAZ) is distanced from the skin that can breath, and the heat can of course follow the chimney and the paths prevailing upward like the neck and chest, permitted for the jacket opening, which can be modified and added to improve and increase the areas of exchange ventilation. Everything is made even without forced ventilation. Obviously, in the absence of any clothing worn over the fabric TAZ, the chimneys of thermal dispersion and ventilation and breathability are spread over the entire surface of the fabric itself TAZ.

### Reduced Thickness Fabrics TAZ

To achieve a reduced thickness for Tissues TAZ, can be used intermediate layer made with ventilation channels build with a particular angle, such that the extent of the open channel length is greater than the thickness. In fact, for an inclined channel over thirty degrees, a millimeter thick can match length mosquito proboscis tolerated than 4 mm in length. In this way the fabric is able to repel attacks and prevent insect and mosquitoes bites, while maintaining a high transpiration despite a limited thickness. Indeed, the inclination guide the proboscis of the insect in one direction tangent to the skin, not allowing a perpendicular entrance. A simple technique to make these channel, is to slide to a default measure the layer outside the inner layer, creating a tension that compels the lateral intermediate layers to achieve the desired angle. The “guide proboscis” channel can have openings side that allow all breathability also parallel to the plan or other plans directions of the surface skin, in addition to inclined transpiration.

### DETAILED EXPLANATION WITH EXPLANATORY DRAWINGS

### Solution and Disposition Examples—Drawing 1

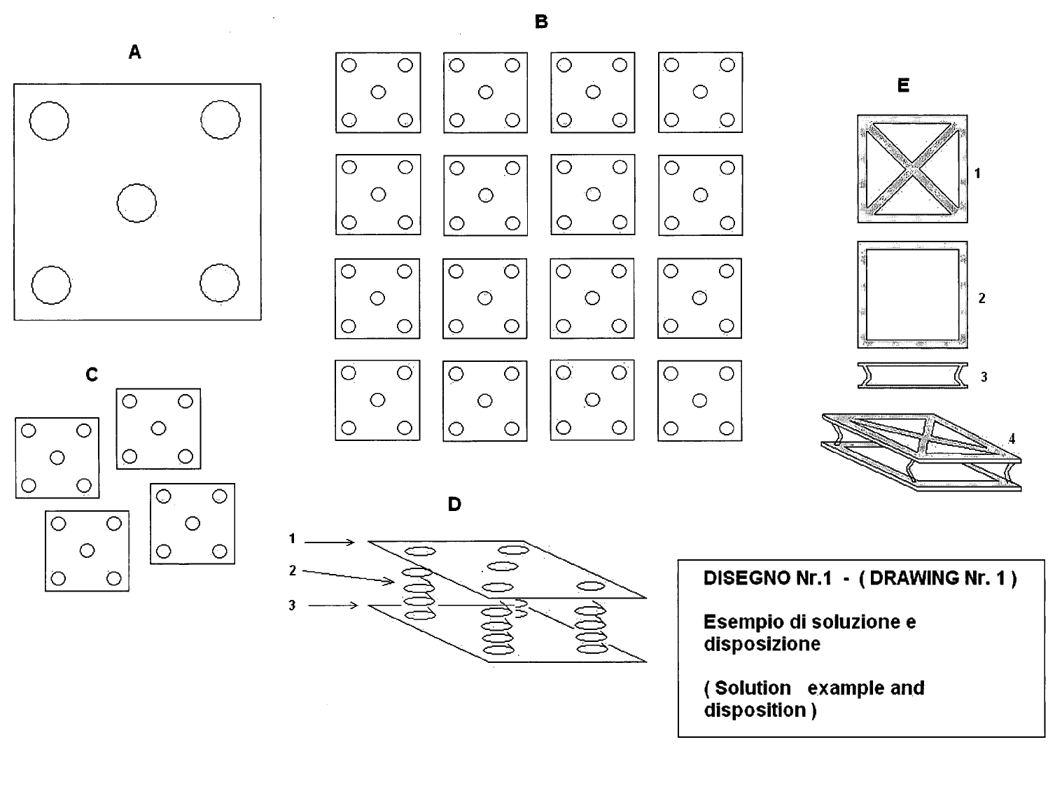

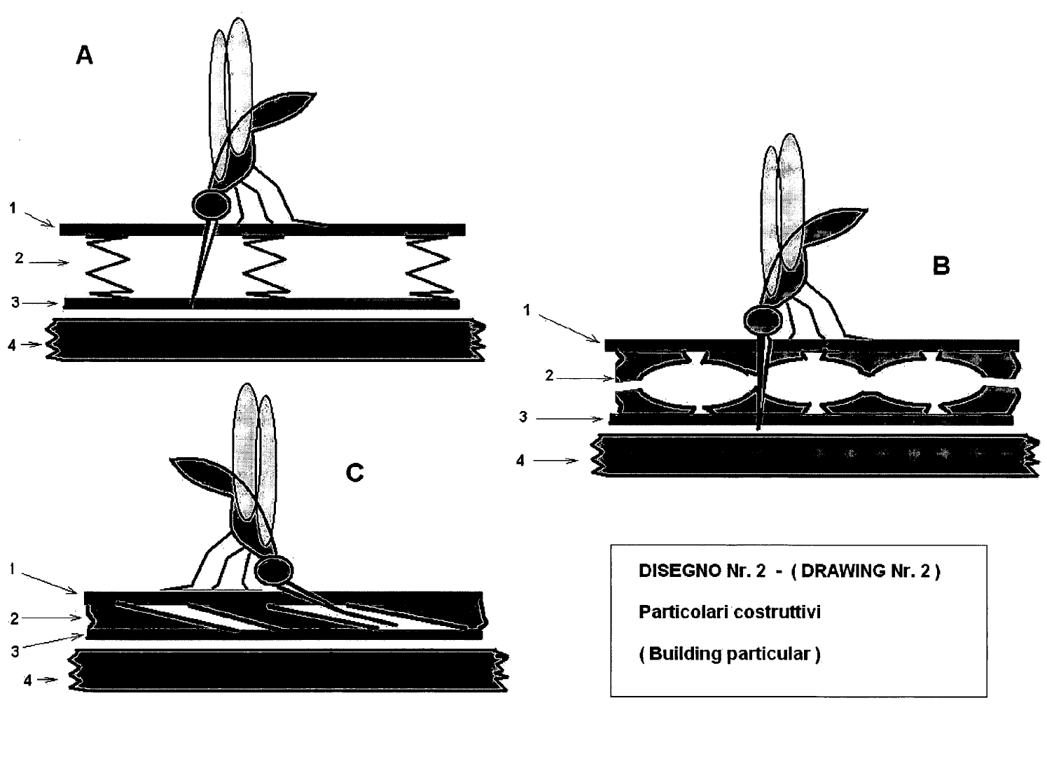

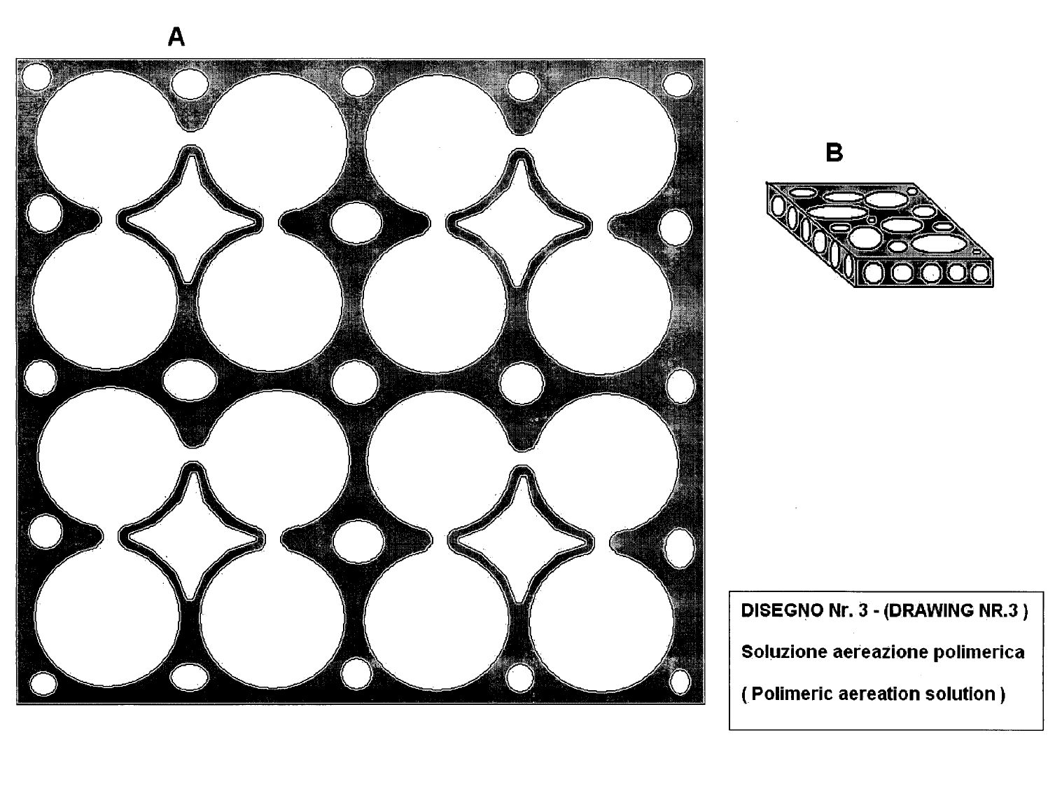

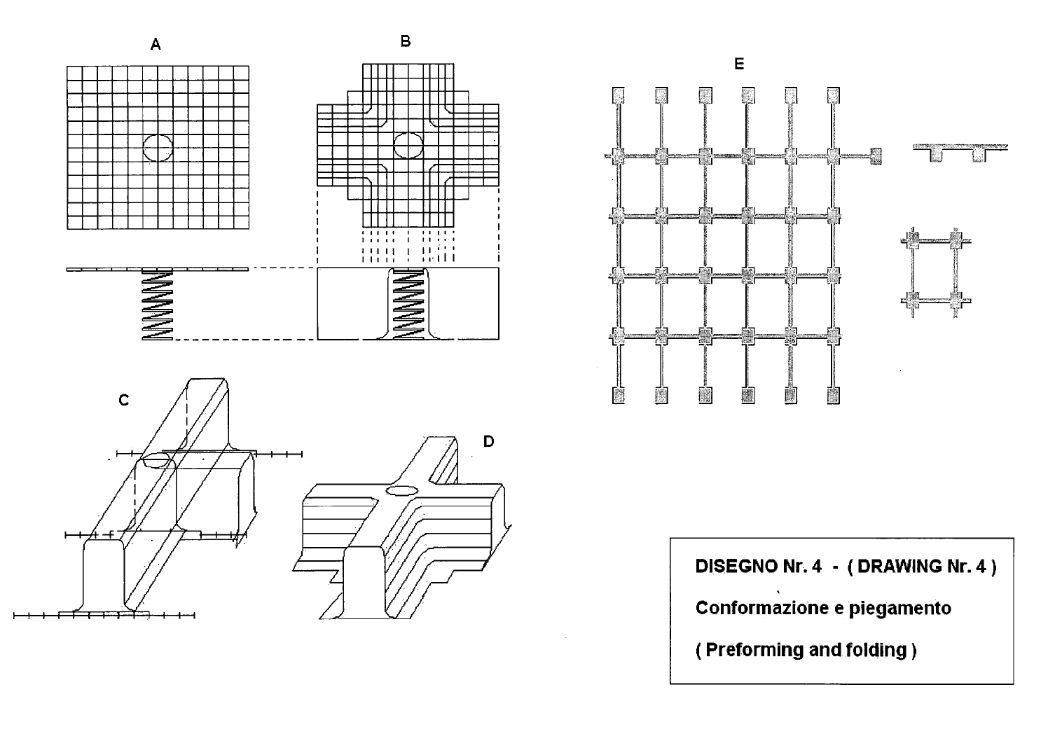

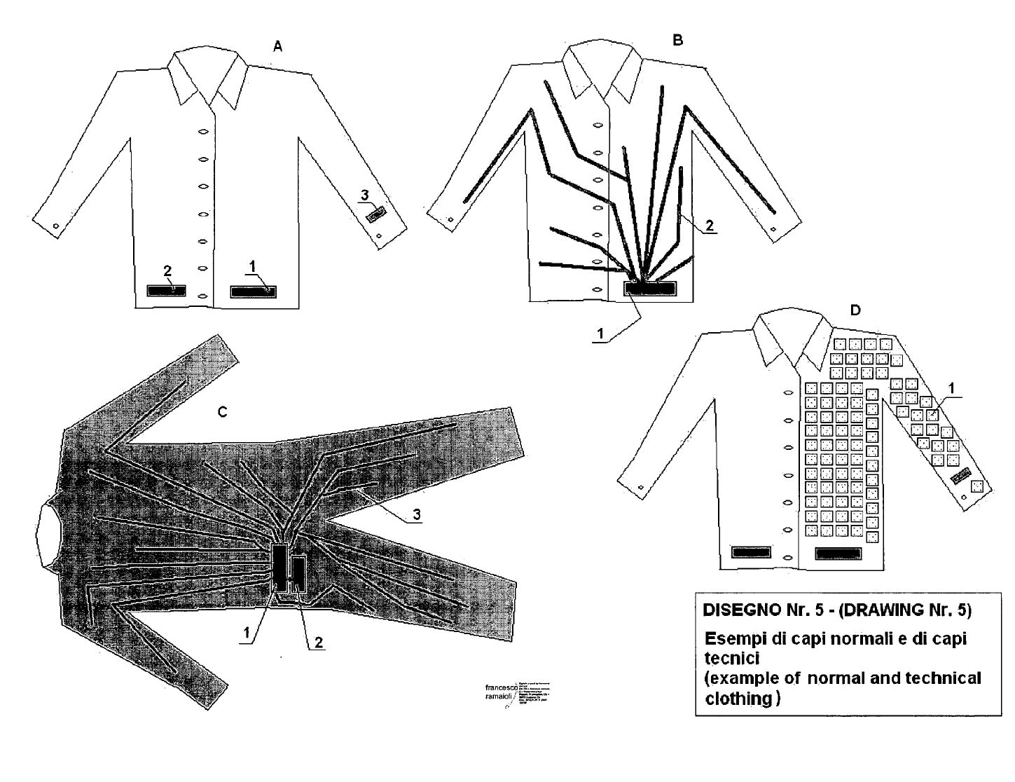

FIG. A (FIG. A Drawing 1): shows the arrangement of 5 springs (FIG. 2 D Drawing 1), which make the middle part; these are enclosed and topped by a fabric or outer material (FIG. 1D Design 1) and materials or underlying tissue that makes the inside (FIG. 3D Design 1)

FIG. B (Figure Drawing 1B) indicates the ideal arrangement for which the sets are side by side type at a suitable distance between them, this distance has the greatest flexibility of the outer fabric that binds them (as the fourth layer to layer overlay 1 or in substitution for that) to the individual parts can be sewn or glued into the fabric of the garment.

FIG. C (FIG. C Drawing 1) show a further provision of assembly A (FIG. A Drawing 1). This provision gives a limited flexibility and save assembly type A quantity for surface.

FIG. D (FIG. D Drawing 1): indicate the physical composition of assembly A (FIG. A Drawing 1), whereby the fabric or material 1 (1 D Drawing FIG. 1) provides the portion specific external or outer layer, usually more hard to ensure better distance maintenance from the fabric or material 3 (3 D Drawing FIG. 1) and/or from skin. The material 2 (FIG. 2D Drawing 1), for example springs, makes or implements an intermediate layer. The fabric or material 3 (3 D Drawing FIG. 1) makes the internal layer, that is what may be in contact with skin. It may also be a net cotton, and its purpose is to minimize the tissue in contact with skin and contain the above layer.

FIG. E (FIG. E Drawing 1): Indicates a special solution made with single material, such as plastic, metal, fabric impregnated with resin or glue, or by molding together two different materials. In this version the spring type elastic behavior is guaranteed by the particular visible in FIG. 3 (3 FIG. E Drawing 1) represented by the parties that seem to be two opposing parentheses. These parties shall ensure the maintenance of distances by elastic behavior, so in case of temporary compression, the tissue TAZ or TAZ system implemented by multiple use of this solution, resumed its original shape after compression of an area.

To clarify the drawing, you show the view 1 as an outer layer (1 FIG. E Drawing 1) and top view, FIG. 2 is the inner layer (2 FIG. E Drawing 1), while FIG. 3 (3 FIG. E Drawing 1) is a side view with the springs, developed by the parties in opposed parentheses and build the intermediate layer. View 4 (4 FIG. E Drawing 1) represents a three dimensional isometric view of the particular, which achieves the same function of the particular in FIG. A (FIG. A Drawing 1), in this case using only four particular with spring behavior.

### Constructione Details Examples—Drawing 2

FIG. A (FIG. A Drawing 2) shows the operating principle of anti-insect tissue, produced by the outer layer 1 (1 FIG. A drawing 2), the intermediate layer 2 (2 FIG. A Drawing 2), the inner layer 3 (3 FIG. A Drawing 2). in this case the intermediate layer is made with springs, or similar parts as the plastic inserts, that perform the same function as elastic one.

These springs or parts are fitted with suitable distance such that the semi-rigid layer 1 (FIG. 1A drawing 2), to prevent lower to layer 3 (FIG. 3A Drawing 2), as well as a calculated measure. The minimum size is defined minimally useful distance, and it is that while guaranteeing the defense against insects and/or warrant the aeration tends parallel to the skin and/or fabric.

FIG. B (FIG. B Drawing 2) shows the operating principle of anti-insect fabric, made by the outer layer 1 (1 FIG. B Drawing 2), the intermediate layer 2 (2 FIG. B Drawing 2), the inner layer 3 (3 FIG. B Drawing 2).

In this case the intermediate layer is achieved through a cellular material that provides three-dimensional ventilation, or at least tend parallel to the skin and/or fabric ventilation. In addition to this ventilation or as an alternative to this, is however still maintaining the anti-mosquito or anti-insect function.

FIG. C (FIG. C Drawing 2) shows the operating principle of anti-insect tissue, produced by the outer layer 1 (1 FIG. C Drawing 2) the intermediate layer 2 (2 FIG. C Drawing 2), the internal layer 3 (3 FIG. C Drawing 2). In this case the intermediate layer is produced by a material that provides protection from insect bites with a reduced thickness so that diminishes the distance between the layer 1 (1 FIG. C Drawing 2) and layer 2 (2 FIG. C Drawing 2). In this case the tend parallel ventilation to skin or tissue can be achieved through communication channels between inclined channels, properly made to not disturb the stings or proboscis guidance in the desired direction.

### Ventilation Solution Through Polymer—Drawing 3

FIG. A (FIG. A Drawing 3): it shows a particular realization solution of intermediate layers, and in which case is more than the empty part that the material parts that is used to maintain separate internal and external layers.

FIG. B (FIG. B Drawing 3) shows the solution in three-dimensional view, showing the capsules open in each direction, to ensure the three-dimensional ventilation or trend parallel aeration to the skin and/or fabric. This aeration also provides the anti-mosquito function.

### Conformation for External or Internal Tissue—Drawing 4

FIGS. A, B, C, D (Drawing 4) shown a particular solution that sees the external or internal fabric or material, bent in particular mode as shown, in order to maintain an appropriate rigidity or semi-rigidity, to ensure both the maintenance to the minimum distance that the ventilation.

In particular, the picture A (FIG. A Drawing 4) is a simplification, while FIG. B (FIG. B Drawing 4) is an orthogonal projection drawing that shows the source size from the picture A (picture A Drawing 4), with further developments to plans folder.

FIG. C (FIG. C Drawing 4) shows the procedure of bending or preforming in a particular direction. FIG. D (FIG. D Drawing 4) is a isometric view of FIG. B (FIG. B drawing 4) FIG. E (FIG. E Drawing 4) represents a further solution created by cellular with open cell, whose behavior in to the corners (intersections) is comparable to that with the spring use that it replaces.

### Example of Realization of Normal Clothing and Technical Clothing—Drawing 5

The examples in FIGS. A, B, C, D (Drawing 5) relate to normal and technical clothing. In particular, the picture A (FIG. A Drawing 5) refers to a clothing appears normal, but below shows the system TAZ or TAZ fabric (breathable anti mosquito), this figure also shows one or more ventilation systems forced 1, 2, 3 (1, 2, 3 FIG. A Drawing 5) which can be added as another optional accessory to increase the capacity to breathe mainly tend horizontal, that one tends to parallel or parallel to the skin and/or fabric.

FIG. B (FIG. B Drawing 5) shows a garment or a shirt that uses the forced ventilation system (1 FIG. B Drawing 5) improved through canals partially breathable 2 (2 FIG. B Drawing 5) that direct the flow, which can be also fluid or gas different from the air, such as nitrogen gas properly mixed or diluted.

The canals or tissue can mount proper electrical sensors that reveal the biological parameters such as temperature, and allow to adjust or partial or addressing the fluids flow to control (e.g. decrease) the temperature in different parts of the clothing and in result in different parts to skin of wearer.

FIG. C (FIG. C Drawing 5) is a technical garment, such as the uniform of a firefighter, who in addition to having the system or fabric TAZ or alternatively to this, can put a series of pipes partially breathable (e.g. tubes with small holes) from which one or more generators 1 (1 FIG. C Drawing 5) can send and adjust flow of fluids, uses a distribution network of partially breathable grooves 3 (3 FIG. C Drawing 5) that lead to regular and induce (independently) also peripheral areas of arms and legs. The particular 2 (2 FIG. C Drawing 5) represents a container that can be separated from the generator/controller 1 (1 FIG. C Drawing 5) which contains the temperature control fluids (technical gases) such as liquid nitrogen expanded in gas through appropriate controlled expansion.

FIG. D (FIG. D Drawing 5) represents a normal clothing, showing the left side (right in front view as drawing looking) a under vision to the fabric, which displays part 1 (1 FIG. D Drawing 5) that delivers breathable function and/or mosquito defense, properly assembled or dispersed in the clothing production.

The particular 1 (1 FIG. D Drawing 5) corresponds to detail A of FIG. 1 (FIG. A Drawing 1) and assembled B Drawing 1 (FIG. B Drawing 1)

### THE BEST MODE TO REALIZE THE INVENTION

The best effective way to creating the invention, in order to maintain raised the outer fabric from the skin, is to apply to the garment fabric a discontinuos number of detachment elements, bilayer or trilayer model, appropriately shaped.

You can use appropriate shape pieces, for example square shaped, whose most external part is made with slightly more rigid tissue or mesh, while the internal part in contact with the skin is made according as previous description. These pieces can be assembled on the outer fabric, keeping a distance between them. This distance can be equal to the thickness of the invention.

The height or thickness is calculated between outer and inner layers, and that is equal to measure of intermediate layer added to internal and external materials thickness measure. Where the fabric will force the discontinuos elements to be close together (e.g. following movements of the user) the guaranteed minimum distance, defined hereafter DMG, will be equal to 2 times thickness of External layer+½ of total thickness. This distance must still be effective for the purposes anti mosquito and/or breathable.

### PRIOR ART

This solution is particularly innovative, the search for prior art has not found anything relevant or comparable. In the ambit of existing Technologies within the anti-mosquito applications there are those what involving tissue treated by impregnating with chemicals products, such as permethrin and other substances toxic or repellent.

### EXAMPLES OF ACHIEVEMENTS FOR OBTAINING INVENTION

Used to make clothes and garments such as examples shirts and blouses, the invention can withstand the attacks of insects, even if they try in vain to insert the sting or the proboscis. Having only resistance technical made with mechanical defense, no complications there are arising from chemical allergies or limitations due to duration of washes. The invention is sufficiently comfortable, despite its articulated configuration.

Excellent result is given by the ventilation airflow, that flowing for induced method or for natural method, with excellent performance for better comfort respect than any other breathable fabric. Indeed, the comparison with the best fabrics and breathable strongly advantage in favor of the present invention, since the characteristics of the invention provide improvements equivalent to 2000/100% already only for appearance breathable. With adding function as anti mosquito for resolution to the problem of annoying insect, improvement is more evident. The distance between the outer fabric from the skin, in addition to solving the problem of improving the perspiration, it also allows an insensitivity considerable to heat: infact if the fabric is exposed to the sun and it heats, the underlying skin does not perceives the heat of the tissue, solving another problem as that of thermal insulation.

1-12. (canceled)

13. A tissue or a TAS system characterized by the fact that it is mosquito resistant and/or high breathability in multiple directions, including that tend to parallel to the surface of the body.

14. A tissue or a tas system characterized by the fact that brought about by the assembly of layers, these layers are:
a) a layer or outer layer composed of a generic tissue plotted or drilled,
b) a middle layer that ensures the maintenance of distance from the skin's by the outer layer or layers, which are away;
c) an inner layer that provides mechanical retention and/or hygienic contact with the user.

15. A tissue or a TAS system according to claim 14, characterized by the fact that it is made in such a way that the outside part is not in direct contact with the skin of the user; this distance allows breathability perpendicular and/or parallel and/or longitudinal to the plane of the skin of the user.

16. A fabric according to the claim 15, characterized by the fact that the distance or the system of spacers or spacers maintain elasticity in order to restore any occasional or repetitive compressions.

17. A tissue or a TAS system according to claim 15, characterized by the fact that the obtained distance between the outer layer and the skin (or surface to be protected) is sufficient to prevent insects stings or other animals that can sting and or remove the blood and/or inoculate fluids and/or substances (poisons, anticoagulants, etc.).

18. A tissue or a tas according to claim 14, characterized by the fact that it is built with an intermediate layer with reduced thickness, while keeping the defense from animals, by tunnel achieved by tilting the ventilation path, in order to drive the proboscis or the sting (or anything offensive) in a physical path that has a greater measure to clothing thickness and/or that guide tangentially the sting and/or the proboscis of the mosquito (or any element offensive) than the surface of the skin, ensuring breathability on one or more plans and/or on one or more directions.

19. A fabric or a tas system according to claim 14, characterized by the fact that it uses means of a forced ventilation system to increase the flow of air that tends to travel on parallel plans of skin, creating the so-called tissue “semitecnico” (half technical fabrics), said system can use a fan with rechargeable batteries including also the technique of “energy scavenger” that uses the movement, the difference thermal, light as an element of energy production and/or timed activation and/or temporary.

20. A fabric tas according to claim 14, characterized by the fact that it uses appropriate fluids to further help improve exchanges of heat and ventilation and/or to obtain fireproof behavior, said fluids may be driven by an array of channels created by the fabric itself by limiting part of breathability and/or aeration, this canalization is used to distribute homogeneously the fluid passage and therefore the consequently resulting effects, even in the suburbs more distant from the point of distribution, particularly this tas is defined “technical fabrics” (tessuto tecnico) for applications in extreme conditions (e.g. high temperatures) and/or to make a retardant fire fabric or retardant fire garments; said tas technical is intrinsically characterized (and without aids) from thermal insulation property because the outer layer is not direct contact with the skin of the user.

21. A fabric or tas system according to claim 14, characterized by the fact that it uses a control unit and several sensors to control ventilation, and/or control fluids release, both in terms of quantity(intercepted quantity) and in terms of areas (preferential direction or for addressing guidance into specific areas on the basis of a termic differentiation or a differential compensation).

22. A fabric or a tas system according to claim 14, characterized by the fact that is brought about by discontinuous geometries (e.g. squares) connected by a fabric finishing or other materials, such geometries can be separated in order to give additional flexibility generally, keeping the defense and/or aeration.

23. A fabric or a tas system according to claim 22, characterized by the fact that is brought about by cellular geometry (cell also open) that make up the intermediate layer, called alveolar geometries are adequate materials to make the transition and/or exchange on most three-dimensional axis of fluid, which passes through the gaps and funnels.

24. A fabric or a tas system according to claim 14, characterized by the fact that is brought about by the use of pre-formed shapes and/or printed and/or joined formed that make up the intermediate layer.
